(19) United States
(12) Patent Application Publication
(10) Pub. No.: US 2007/0266042 A1
(43) Pub. Date: Nov. 15, 2007

(54) Methods and systems for report retrieval and presentation

(76) Inventors: Ming-Ta Hsu, Hsinchu (TW); Rong-Wei Chen, Taipei Hsien (TW); Li-Wei Liu, Hsinchu (TW)

Correspondence Address: BIRCH STEWART KOLASCH & BIRCH, PO BOX 747, FALLS CHURCH, VA, 22040-0747, US

(21) Appl. No.: 11/500,450

(22) Filed: Aug. 8, 2006

(30) Foreign Application Priority Data
May 11, 2006 (TW) 095116692

(51) Int. Cl. G06F 7/00

(52) U.S. Cl. 707/102

(57) ABSTRACT

A method for report retrieval and presentation. An agent receives and stores subscription and time setting for subscribed reports provided by a reporting system from a client computer. The agent automatically requests for and then receives a report of a subscribed report at the time indicated by the time setting. When the client computer completes boot up, a viewer directly presents the report on the desktop of the client computer without need for triggering by user action or authentication.

### BACKGROUND OF THE INVENTION

1. Field of the Invention

The invention relates to computer techniques, and more particularly to report retrieval and presentation methods.

2. Description of the Related Art

In the conventional n-tier client-server architecture, user interfaces, application logic, and the data are respectively stored in different platforms comprising one or more client computers, servers, and databases. Application servers extract various data from databases according to data format and generate reports therefrom. A database joins tables in response to queries from the application servers. Typically, a database is normalized to eliminate redundant records and maintaining data dependencies, this complicates join operations, however, demanding greater computing resources and increased processing time. When databases are utilized to save enormous amounts of daily trading activity, as with the millions of transactions per day on the Internet or on other networked telecommunication service, join operations may be time consuming and cause efficiency degradation for the entire database, potentially leading to suspension of trading.

Data warehouses may be utilized to ameliorate the described problems. FIG. 1 shows an exemplary configuration of a database and a data warehouse, where block 101 comprises a conventional n-tier client-server architecture comprising database 102. Roughly speaking, ETL (referring to Extract, Transform, and Load) tool 103 extracts data from database 102 and transforms and loads the transformed data into data warehouse 104. The first step of an ETL process comprises mapping data between a source database (such as data database 102) and a target system (such as data warehouse 104). The second step comprises cleansing source data in a staging area. The third step comprises transforming cleansed source data and then loading transformed data into the target system. The cleansing process resolves data inconsistencies and anomalies in source data. ETL may further integrate source data from more than one source system into data warehouse 104.

After denormalization by the ETL process, the data warehouse provides data more appropriate for application servers and responds more rapidly to queries. Application server 105, web sever 106, customer relationship management (CRM) system 107, supply chain management (SCM) system 108, or clients in block 109 may retrieve data from data warehouse 104, analyze, and process the data to generate reports, which may be treated as business intelligence (BI) for reference by decision support systems (DSS) or expert systems.

An application executed in a client computer (in block 109) may request reports from application server 105, web server 106, CRM system 107, and SCM system 108. Although these application servers extract data from the common source data warehouse 104, they may have been designed to cooperate with respective application clients on one client computer and different security mechanisms. Thus, a server in FIG. 1 provides reports through a network to a user only when the user is authenticated when logging on to a server utilized by the client computer. This complicates report queries.

### BRIEF SUMMARY OF THE INVENTION

A detailed description is given in the following embodiments with reference to the accompanying drawings.

An exemplary embodiment of a report retrieval and presentation method is implemented by an agent providing report subscription services and comprises the following steps. When a report subscription service is initiated, an agent receives and stores report subscriptions, referred to as first subscribed reports, provided by a reporting system from a first client computer. The agent further stores time settings. A first report of the first subscribed reports is automatically requested and retrieved at the time indicated by the time setting according to the subscription. When a transmission condition in the time setting is satisfied, the first report is automatically transmitted to the first client computer to enable presentation of the first report on the desktop of an operating system of the first client computer.

An exemplary embodiment of a report retrieval and presentation method is implemented by an agent providing report subscription services and comprises the following steps. When a report subscription service is initiated, an agent receives and stores report subscriptions, referred to as first subscribed reports, provided by a reporting system from a first client computer. The agent further stores time settings. A first report of the first subscribed reports is automatically requested and retrieved at the time indicated by the time setting according to the subscription. A first viewer automatically displays the first report on the desktop of an operating system of the first client computer thus bypassing the login process for retrieval of the first report.

An exemplary embodiment of a report retrieval and presentation system comprises an agent and a viewer. The agent, coupled to a first client computer, initiates a report subscription service by receiving and storing report subscriptions, referred to as first subscribed reports, provided by a reporting system from the first client computer, stores a time setting, automatically requests and retrieves a first report of the first subscribed reports at the time indicated by the time setting according to the subscription. When a transmission condition in the time setting is satisfied, the agent automatically transmits the first report to the first client computer. The viewer executed by the first client computer displays the first report on the desktop of an operating system of the first client computer.

### BRIEF DESCRIPTION OF THE DRAWINGS

The invention can be more fully understood by reading the subsequent detailed description and examples with references made to the accompanying drawings, wherein:

FIG. 1 is a schematic view showing the configuration of a network comprising a database, an ETL tool, and a data warehouse;

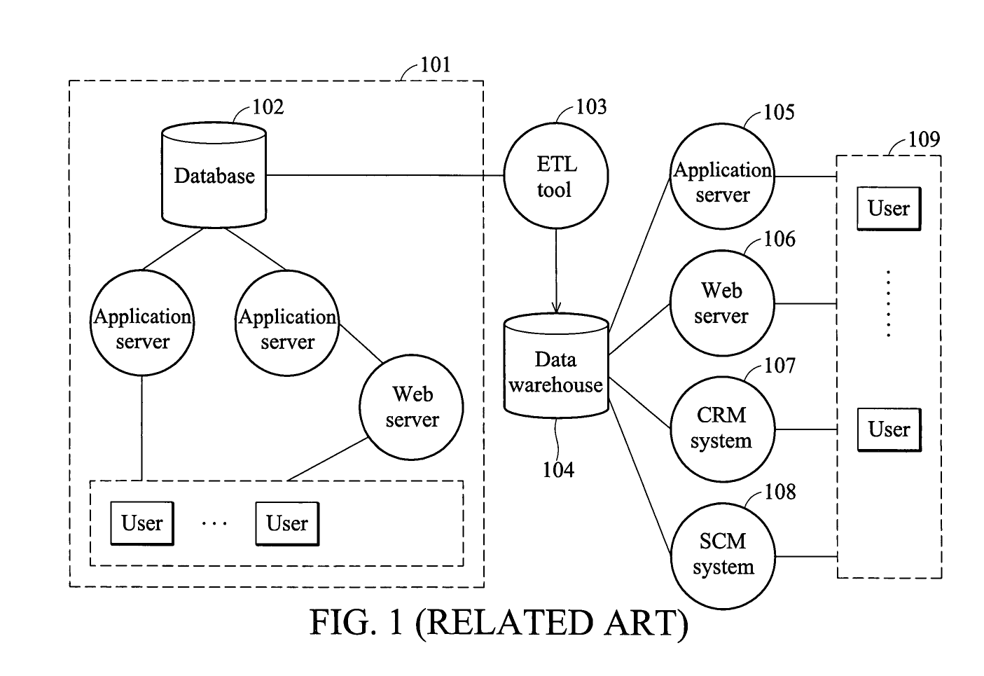

FIG. 2 is a schematic view showing an exemplary embodiment of an agent connecting to the network;

FIG. 3 is a flowchart showing an exemplary embodiment of a method for report retrieval and presentation;

FIG. 4 is a schematic view showing subscription settings for reports;

FIG. 5 is a flowchart of an exemplary embodiment of a report inquiry;

FIG. 6 is a flowchart of an exemplary embodiment of communication between an ETL tool and an agent;

FIG. 7 is a flowchart of an exemplary embodiment of report transmission;

FIG. 8 is a schematic view showing interfaces of a integrated viewer; and

FIG. 9 is a schematic view showing another exemplary embodiment of an agent connecting to the network.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Report retrieval and presentation methods and systems are provided.

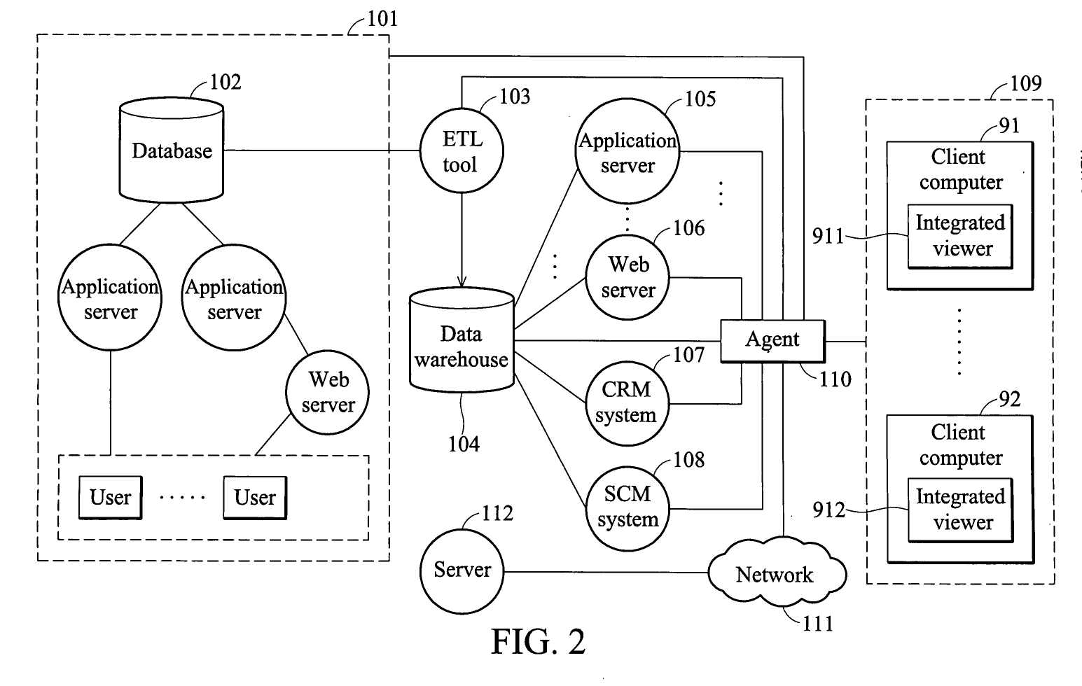

With reference to FIG. 2, agent 110 is coupled to application server 105, web server 106, CRM system 107, SCM system 108 and a plurality of client computers (shown in block 109). Client computers may comprise personal desktop computer, laptops, personal digital assistant (PDA), mobile phones, pagers, or other electronic devices. Agent 110 providing report subscription services may be implemented by computer programs executable on one or more computers. Agent 110 may be executed in the form of a background program (a daemon) on a multitasking operating system (OS). Each client computer (such as client computer 91) comprises an integrated viewer (such as integrated viewer 911) interactive with agent 110. An integrated viewer and an agent both can be daemons or applications executable by a computer. The integrated viewer may store the internet address of agent 110, acquire and transmit user accounts and passwords to agent 110 which then authenticates and authorizes the user to access report subscription services. Note that a user may be authenticated prior to report subscription. After subscribing, agent 110 directly transmits subscribed reports to viewers on client computers without further user authentication. An integrated viewer and an agent may be bundled as one application or separated into two applications for execution by on one or more computers. Note that any connection between two entities in FIG. 2 may be a cabled or wireless connection.

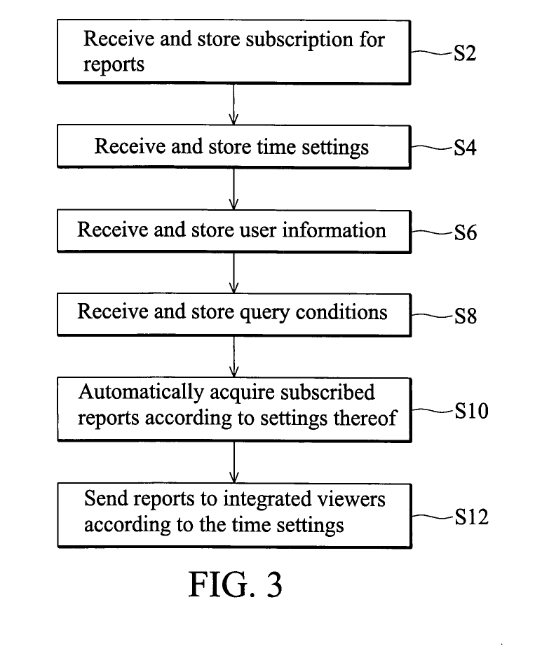

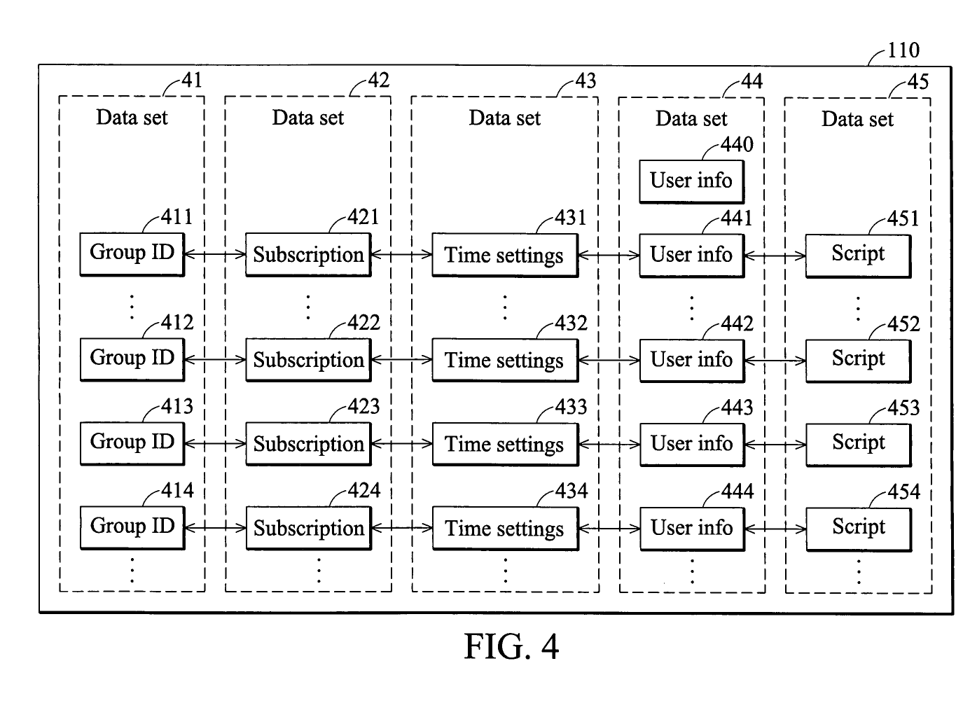

With reference to FIG. 3, agent 110 receives and stores subscription (step S2) and time settings (step S4) for one or more reports, user information (step S6), and query conditions (step S8). An integrated viewer may display a graphical user interface (GUI) for receiving and providing said data to agent 110. As shown in FIG. 4, agent 110 may store the received data in a storage device. For example, data set 41 comprises group identification (ID) of subscribed reports (such as 411-414) which may be stored with subscription ID codes or names retrievable from interfaces of integrated viewers. Data set 42 comprises subscription information (such as 421-424) of respective subscribed reports, which may comprise beginning and ending times of the subscription and a binary value indicating validity of the subscription. Data set 43 comprises time settings (such as 431-434) of the subscribed reports, which may comprise predetermined times for report query and transmission to client computers. The predetermined time may be set as a specific time instance, a period, a specific event (such as a reception event of a database update notice), or a session in a schedule according to which agent 110 begins report query or transmission. Data set 44 comprises user information records (such as 441-444) corresponding to subscribed reports, each comprising user accounts and passwords for entering into a security mechanism (such as authentication and authorization processes) of reporting systems. Data set 45 comprises report query scripts (such as 451-454) for subscribed reports. Addresses (such as Internet protocol (IP) addresses) of reporting systems are also stored for reference by the scripts. Integrated viewer 911 may provide interfaces for configuration of these data, receive and transmit these data to agent 110.

User information comprises user information 440 verifiable by agent 110 and other sets of user information for accessing various reporting systems. User information may comprise user accounts, passwords, and corresponding computer addresses. Agent 110 may compare user information 440 with received user accounts and passwords to identify users and authority thereof, and accordingly determine whether to provide report subscription service thereto. After retrieving subscribed reports, agent 110 may directly transmit subscribed reports to computers of users subscribing to the reports without further user authentication. Note that these data sets may be arranged in different data structures in different storage devices which may or may not be installed in the same computer of agent 110. The settings for a group of subscribed reports comprise corresponding subscription information, time settings, user information, and scripts. Each subscribed report is generated from data extracted from data warehouse 104 or database 102 by an application server (a report writer or a reporting system) or a web server. Queries for reports in a single reporting system may be designed variously by utilizing scripts stored in data sets 45. For example, a script comprises instructions, query conditions; scope, and output data, format. These settings may be set via interfaces provided by agent 110 or interfaces displayed on an integrated viewer (such as integrated viewer 911). Agent 110 may automatically generate scripts based on received settings.

A plurality of users may subscribe to a group of reports, and an individual user may subscribe to different groups of reports. Thus, group ID codes in data set 41 and user information records in data set 44 may have a one-to-many or many-to-one relationship. Agent 110 automatically acquires subscribed reports according to settings of each report group (step S10) and sends the retrieved reports to integrated viewers according to transmission time in the time settings (step S12). Because transmission time is predefined in the subscription settings, report transmission is automatically performed without user reconfirmation or requiring request from client computers. Agent 110 preferably transmits retrieved reports to an integrated viewer on a client computer following boot up or connection thereof to a network. It is assumed that a user of client computer 91 subscribes to report groups 411-414. An integrated viewer may immediately display reports upon retrieval thereof, or when executed in form of a background program receiving reports during execution of other foreground programs, display retrieved reports at a predetermined time, such as after computer boot up, or on demand. Preferably, an integrated viewer automatically displays the most current reports after computer boot up without requiring triggering signals or data from computer input devices (not shown).

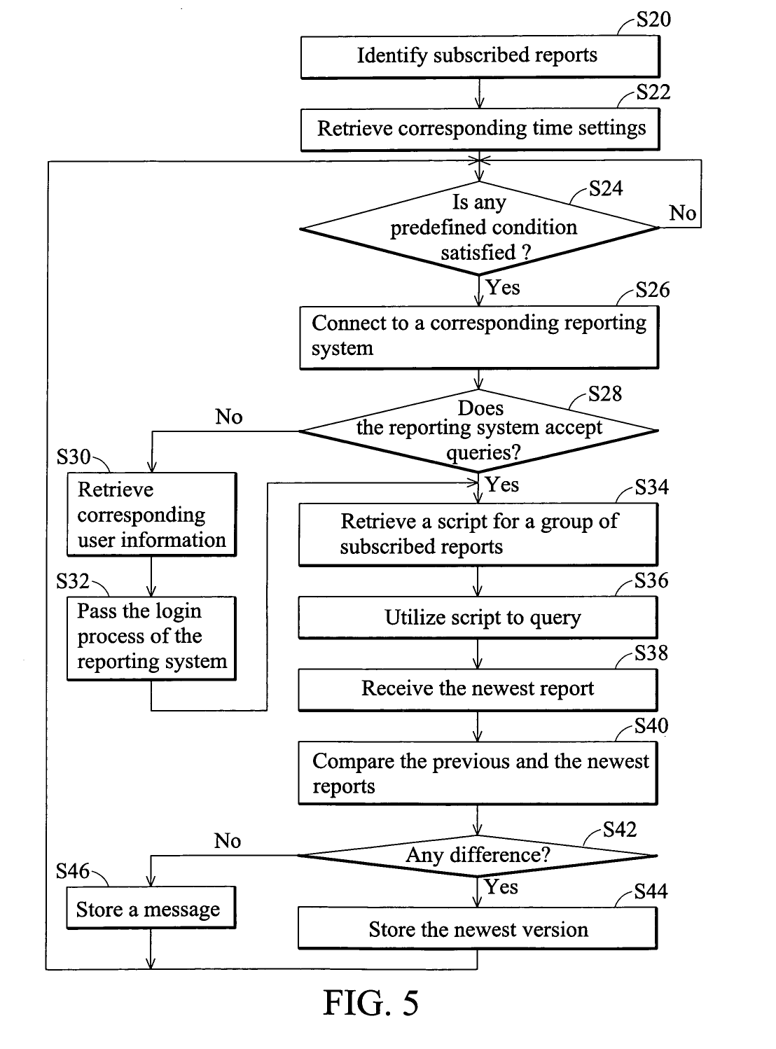

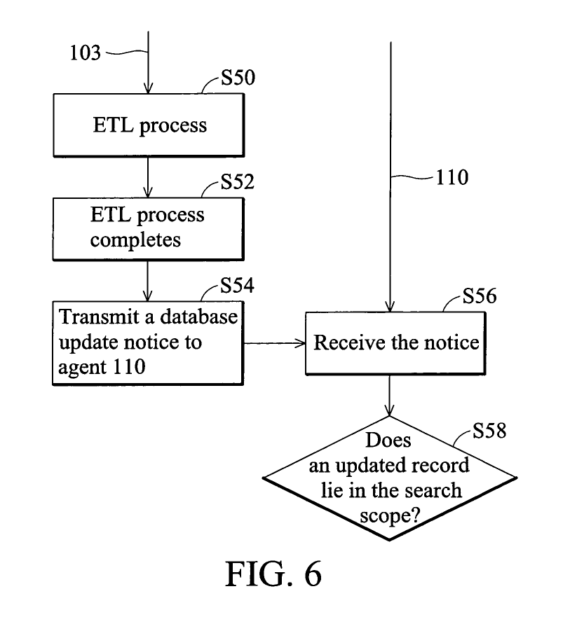

The following descriptions are respectively given based on particular time settings with reference to FIGS. 5 and 6. It is assumed that valid subscriptions to groups 411-414 exist. Agent 110 identifies subscribed reports based on the subscription information (step S20), retrieves time settings corresponding to the subscribed reports (step S22), and determines if any predefined condition therein is satisfied (step S24). If not, step S24 is repeated. If so, agent 110 begins a report query process. For example, a redefined condition in time settings may indicate an interval of periods, sessions in a schedule, or a database update event, and may be satisfied when a clock in agent 110 passes an interval or reaches a session of the schedule, or when agent 110 receives a database update notice (such as delivered by ETL 103).

When a predefined condition (referred to as a query condition) in time settings corresponding to a group (or a series) of subscribed reports is satisfied, agent 110 connects to a corresponding reporting system thereof utilizing a stored address (step S26). Agent 110 then determines if the reporting system accepts queries (step S28). If so, step S34 is executed. If not, agent 110 retrieves user information corresponding to the report group subscription (step S30) and accordingly passes the login process of the reporting system utilizing the user information (step S32). Agent 110 retrieves (step S34) and utilizes a script corresponding to the report group subscription to query (step S36) and receive (step S38) a report as the most current version of the subscribed reports. Agent 110 automatically retrieves a user account and password pair from the settings of a report group subscription, and a script directs agent 110 to simulate entry of the user account and password to complete the login process. A script may bypass the login process of the reporting system utilizing application program interfaces (API) provided by the reporting system.

If a previous version of a subscribed report has been received before the most current version, agent 110 compares the previous and the most current versions (step S40) and determines if any difference exists therebetween (step S42). If so, agent 110 stores the most current version (step S44). If there are no differences between the previous and the most current versions have no difference, agent 110 stores a message indicating consistence between the previous and the most current versions (step S46). The message may comprise reception time, comparison result and completion time. Note that agent 110 may determine whether to compare report versions or not based on a stored setting received from an integrated viewer. If the setting indicates not to compare report versions, agent 110 may directly store each retrieved report.

Agent 110 and ETL tool 103 may comprise a protocol directing agent 110 to automatically begin the report query process when receiving a notice of (successful) ETL completion or database update. Alternatively, since a script may comprise a search scope and other settings, agent 110 may determine whether to begin the report query process based on a relationship of an updated record in the update notice and the search scope.

With reference to FIG. 6, ETL tool 103 performs a regular ETL process (step S50). When the ETL process completes (step S52), ETL tool 103 transmits a database update notice to agent 110, comprising the ID code or other information of updated records (step S54). Agent 110 receives the notice (step S56) and determines if the updated records belong to the search scope (step S58). If so, agent 110 begins the report query process. If not, agent 110 does not perform the report query process.

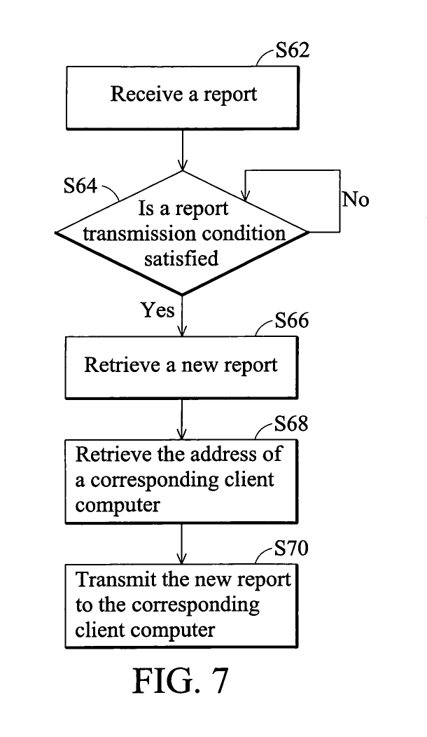

With reference to FIG. 7, after receiving a report (step S62), agent 110 determines if a time setting report transmission condition corresponding to the report is satisfied (step S64). If not, the step S64 is repeated. If so, agent 110 continues to retrieve a new report (step S66), retrieves the address of a client computer (such as computer 109) corresponding to the report (step S68), and transmits the new report to the corresponding client computer (step S70). An integrated viewer may immediately display reports after retrieval thereof, or be executed in form of a background program receiving reports during execution of other foreground programs and display retrieved reports at a predetermined time, such as after computer boot up, or on demand. Preferably, agent 110 transmits received reports to an integrated viewer on a client computer following boot up and connection thereof to a network. An integrated viewer is automatically initiated after computer boot up and displays most current reports without requiring triggering signals or data from computer input devices (not shown).

Report acquisition and transmission time (or conditions) may be identical or not, and may comprise a specific time, sessions in a schedule, a period, or an event. Agent 110 may buffer received reports or immediately push received reports to client computer as soon as receiving them. Agent 110 may detect whether a client computer has booted and accordingly push new reports thereto. Agent 110 may inquire an address allocation server (such as a dynamic host configuration protocol (DHCP) server) whether a client computer has connected to a network and, if so, pushes new reports to the computer.

Integrated viewer 911 on client computer 91 receives reports from agent 110 and displays the reports on a display (not shown). Various reports may require respective dedicated programs (hereafter viewers) for presentation on the display. Integrated viewer 911 integrates of these dedicated viewers of various reports and servers as a dashboard for initiating and terminating dedicated viewers of various reports, arranging and closing reports and a report container. Packets transmitted from agent 110 to integrated viewer 911 may comprise report content and related information thereof according to which integrated viewer 911 may initiate a dedicated viewer to show the content of a received report. Integrated viewer 911 may display subscribed reports in a report container, such as a window, utilizing respective viewers. For example, after receiving reports of groups 411-414, agent 110 transmits the reports to client computer 91. After receiving the reports, integrated viewer 911 displays the reports in respective container utilizing dedicated viewers thereof.

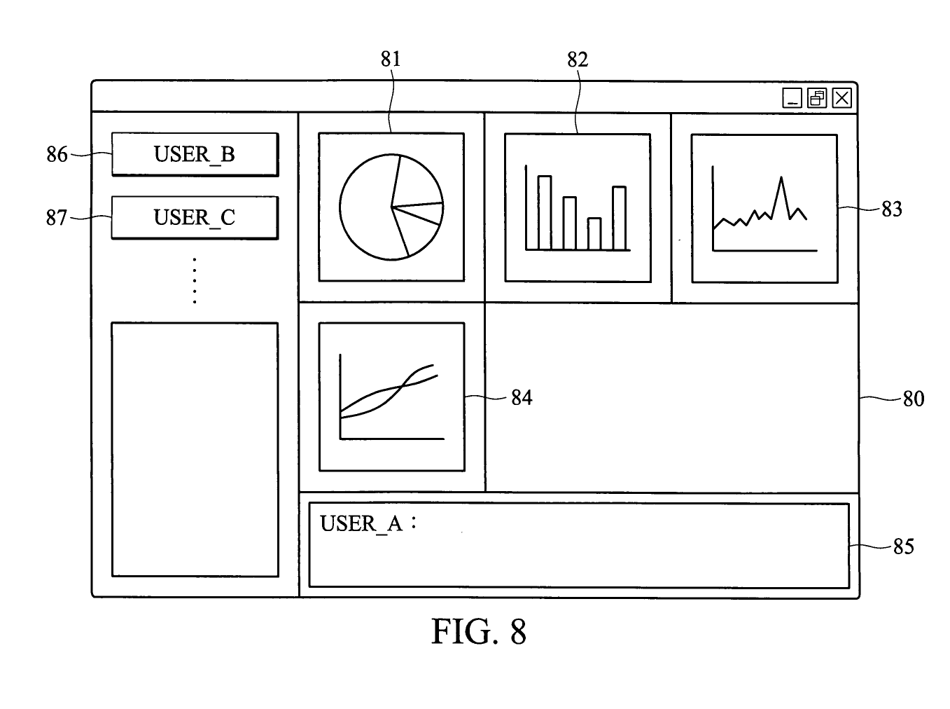

FIG. 8 shows exemplary interfaces provided by integrated viewer 911. Reports of group 411-414 are respectively shown in areas 81-84 of window 80. Note that integrated viewer 911 can respectively display contents of the reports in as many windows. Each of areas 81-84 can be dragged to other locations. Report contents can be dragged to area 85. Area 85 referred to as a dialog box displays messages sent from agent 110 to integrated viewer 911 and receives text input or reports dragged from other locations. Integrated viewer 911 transmits text and reports received by area 85 to agent 110. When a plurality of users enter agent 110 from different computers, agent 110 may receive text and reports from a dialog box of a computer and transfer the same to another dialog box or other containers of an integrated viewer on an assigned client computer utilizing stored addresses. When receiving the transferred reports, an integrated viewer can display the reports in locations within window 80. Agent 110 may transmit information of users which have connected to a network (such as the current network comprising agent 110) to integrated viewer 911, which may display users (such as icons 86 and 87) in communication and assign destination computers or users for text or report transmission. For example, destination computers or users of transmitted text or reports can be assigned by selecting icons 86 and 87 with a cursor. An integrated viewer may display a report upon reception thereof.

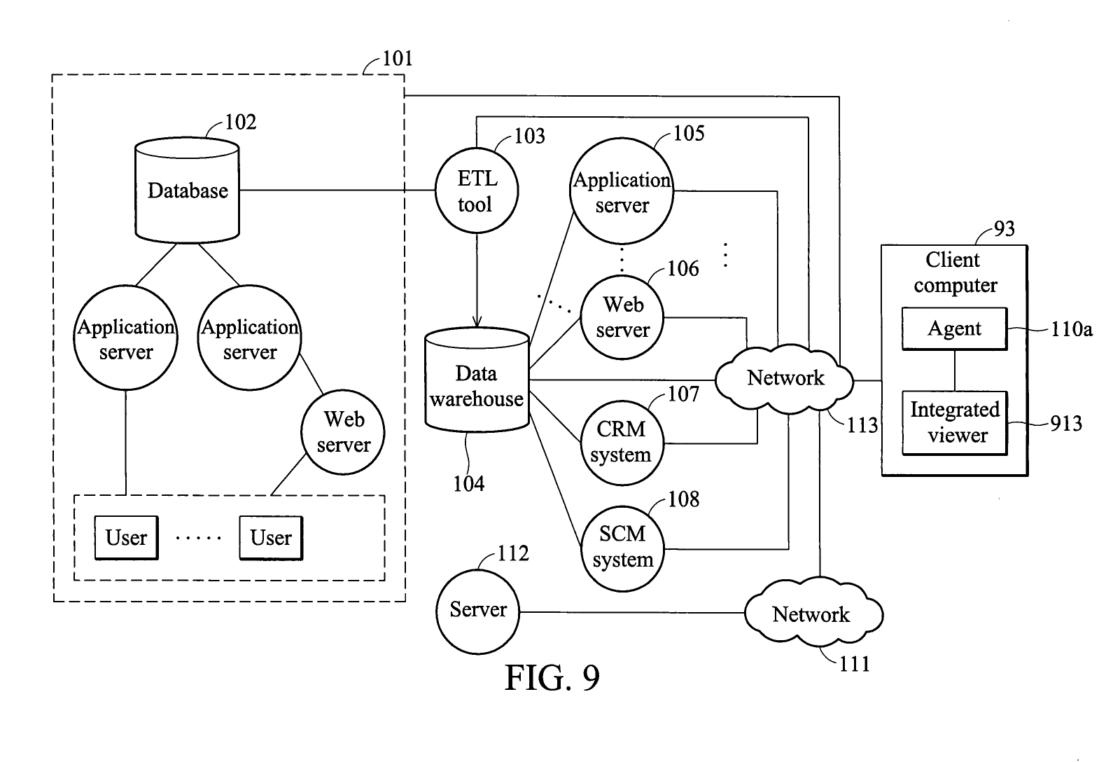

Agent 110 also connects to the Internet 111. Agent 110 may determine whether subscribed reports belong to the Internet or the local network and accordingly accept or reject subscription of these reports. Server 112 may comprise a file transfer protocol (FTP) server. If a user of client computer 91 is to subscribe resources on server 112, an agent (such as agent 110a in FIG. 9) for acquiring subscribed resources is preferably executed on client computer 91.

With reference to FIG. 9, client computer 93 and a plurality of reporting systems are coupled to network 113. Agent 110a and integrated viewer 913 are variations of agent 110 and integrated viewer 911. Different from agent 110, agent 110a is installed in client computer 93. Agent 110 and 110a may be implemented by memory resident programs. Agent 110a acquires reports from respective reporting systems according to settings of subscribed reports and stores acquired reports in a storage device (not shown) in client computer 93. Agent 110a may be executed in form of a background program continuously and automatically acquiring reports until client computer 93 shuts down. For example, agent 110a acquires a most current subscribed report from a reporting system before shutdown of client computer 93. When client computer 93 reboots, integrated viewer 913 is automatically initiated and displays the most current subscribed reports on the desktop of client computer 93 or one or more container thereon. Integrated viewer 913 may display most current or previous reports on demand or upon computer boot up, even if client computer 93 is off line.

Integrated viewer 913 can be temporarily turned off. Agent 110a serving as a background program, when receiving signals of a function key or combination keys, recalls and shows integrated viewer 913 with the last reports therein.

Agents 110 and 110a can gather and analyze statistics of subscribed reports and generate analysis results. For example, an agent can count the times of report acquisition and transmission for each user and locate the most frequently queried reporting system and a group of reports subscribed by most users. Similarly, an agent can count the number of other user operations or interactions with reporting systems and output the counted results.

In conclusion, an agent automatically requests subscribed reports from a specified reporting system utilizing a predetermined query scheme when a predefined time setting is satisfied. The agent makes the reporting system login process invisible on client computers, automatically acquires subscribed reports according to corresponding subscription and time settings, and sends the reports to desktops of client computers for display according to a transmission time without requiring user reconfirmation. If the transmission time indicates a period, the agent periodically performs report transmission to client computers. If the transmission time indicates a predefined event (such as a computer boot up), the agent transmits received reports to client computers when the event occurs. The reporting system may comprise a web server, an application server, or a client computer.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A report retrieval and presentation method, comprising:
initiating by an agent of report subscription service by receiving and storing report subscriptions, referred to as first subscribed reports, provided by a reporting system from a first client computer;
storage of time setting by the agent;
automatic request for and retrieval by the agent of a first report of the first subscribed reports at the time indicated by the time setting according to the subscription; and
when a transmission condition in the time setting is satisfied, automatic transmission by the agent of the first report to the first client computer to enable presentation of the first report on the desktop of an operating system of the first client computer.

2. The method as claimed in claim 1, wherein the reporting system doest not provide any of the first subscribed reports to a user unless the user passes a login process of the reporting system, the agent prevents the login process from being displayed on the first client computer, and the first client computer initiates a first viewer receiving and displaying the first report on the desktop bypassing the login process.

3. The method as claimed in claim 2, wherein a second client computer is coupled to the agent and executes a second viewer, further comprising:
transmitting the first report by the first viewer to the agent;
transferring the first report by the agent to the second client computer; and
upon reception of the first report, automatic display of the first report by the second viewer in the second client computer.

4. The method as claimed in claim 2, wherein the first viewer comprises a dialog box, and transmission of the first report by the first viewer to the agent is performed when the first report is dragged to the dialog box.

5. The method as claimed in claim 2, wherein the agent counts times of interactivities with the first client computer or the reporting system, and outputs the count result.

6. The method as claimed in claim 1, wherein the agent is executed in form of a background program.

7. The method as claimed in claim 6, wherein the agent coupled to the reporting system and the first client computer through a network, further comprising:
querying an address allocation server by the agent to determine whether the first client computer has connected to the network; and
according to the transmission condition, when the first client computer has connected to the network, transmitting the first report from the agent to the first client computer.

8. The method as claimed in claim 1, wherein the transmission condition indicates a period according to which the agent periodically transmits instances of the first subscribed reports to the first client computer.

9. The method as claimed in claim 8, wherein the agent retrieves a previous version and a new version of one of the first subscribed reports, further comprising:
comparing the previous version and the new version for difference therebetween;
when any difference therebetween is located, storing the new version; and
when no difference exists therebetween, storing a message indicating consistency of the previous version and the new version.

10. The method as claimed in claim 1, wherein the agent retrieves the first report from the reporting system before shutdown of the first client computer, when the first client computer boots, the first viewer is automatically initiated and displays the first report in a container of the first viewer.

11. The method as claimed in claim 1, wherein the time setting comprises a condition according which the agent automatically requests for the first report of the first subscribed reports from the reporting system and displays the first report on the first client computer when receiving a update notice from a data warehouse.

12. The method as claimed in claim 11, wherein the update notice is delivered by an ETL tool targeting to the data warehouse, and comprises the identification of a updated record, which is utilized by the agent for determination of whether to request for the first report from the reporting system.

13. The method as claimed in claim 1, wherein the first viewer comprises an application serving as a dashboard for managing initiation, termination, and allocation of dedicated viewers of various reports.

14. The method as claimed in claim 13, further comprising:
storage by the agent of time setting and subscription for second subscribed reports provided by another reporting system;
automatic retrieval by the agent of a second report of the second subscribed reports according to the time setting and the subscription thereof;
reception of the first and second reports from the agent by the first viewer on the first client computer; and
display of the first report and the second report respectively by the first viewer and a second viewer dedicated to the second report in respective containers thereof.

15. A report retrieval and presentation method, implemented in a first client computer, comprising:
initiating by an agent of report subscription service by receiving and storing report subscriptions, referred to as first subscribed reports, provided by a reporting system;
storage of time setting by the agent;
automatic request for and retrieval by the agent of a first report of the first subscribed reports at the time indicated by the time setting according to the subscription; and
automatic presentation by a first viewer of the first report on the desktop of an operating system of the first client computer bypassing login process for retrieval of the first report.

16. The method as claimed in claim 15, wherein, when the first client computer completes boot up, the first viewer is automatically initiated and displays the first report on the desktop.

17. The method as claimed in claim 16, wherein the agent retrieves the first report from the reporting system before shutdown of the first client computer, when the first client computer boots, the first viewer is automatically initiated and displays the first report in a container of the first viewer.

18. The method as claimed in claim 15, wherein the agent is executed in the form of a background program continuously retrieving the first subscribed reports.

19. The method as claimed in claim 18, wherein, after shutoff, the first viewer is revoked retaining its original content when the agent receives a keyboard signal.

20. A report retrieval and presentation system, comprising:
an agent coupled to a first client computer, initiating report subscription service by receiving and storing report subscriptions, referred to as first subscribed reports, provided by a reporting system from the first client computer, storing time setting, automatically requesting for and retrieving a first report of the first subscribed reports at the time indicated by the time setting according to the subscription, and, when a transmission condition in the time setting is satisfied; automatically transmitting the first report to the first client computer; and
a viewer executed by the first client computer, and displaying the first report on the desktop of an operating system of the first client computer.
